(19) United States
(12) Patent Application Publication
(10) Pub. No.: US 2007/0248853 A1
(43) Pub. Date: Oct. 25, 2007

(54) Fuel Cell System And Method For Operating Fuel Cell System

(76) Inventors: Kunihiro Ukai, Osaka (JP); Yasuo Takebe, Kyoto (JP)

Correspondence Address: MCDERMOTT WILL & EMERY LLP, 600 13TH STREET, NW, WASHINGTON, DC, 20005-3096, US

(21) Appl. No.: 11/631,569

(22) PCT Filed: Sep. 27, 2005
(86) PCT No.: PCT/JP05/17685

§ 371 Date: Jan. 4, 2007

(30) Foreign Application Priority Data
Sep. 27, 2004 (JP) 2004-278912

(51) Int. Cl. H01M 8/02

(52) U.S. Cl. 429/17; 429/19

(57) ABSTRACT

The present invention provides a fuel cell system which is capable of appropriately removing nonionic sulfur compound contained in recovered water in a water recovery device, which is used for generating a hydrogen-containing gas in a hydrogen generator, and a method for operating the fuel cell system.

The fuel cell system (100) is comprised of: a hydrogen generator (1) configured to generate a hydrogen-containing gas from a feed gas and steam; a fuel cell (5) configured to generate electric power using the hydrogen-containing gas and an oxidizing gas; a water recovery device (12) configured to recover water generated through the electric power generation; a first water cleaning device (18) including an ion exchanger for removing ionic impurities contained in the water recovered by the water recovery device; a second water cleaning device (17) configured to remove a nonionic sulfur compound contained in the water recovered by the water recovery device, by chemical adsorption; and a water supply passage (40) configured to guide, to the hydrogen generator, the water which has been taken out of the water recovery device (12) and has flowed through the first and second water cleaning devices (18, 17).

### FIELD OF THE INVENTION

The present invention relates to a fuel cell system configured to generate electric power using a hydrogen-containing gas and an oxidizing gas, and a method for operating the fuel cell system. More particularly, the invention relates to a fuel cell system which is able to appropriately remove a nonionic sulfur compound contained in water produced in the fuel cell system and a method for operating the fuel cell system.

### BACKGROUND ART

Compact fuel cell systems enabling high-efficiency power generation have been developed as electric energy supply sources for mobile use and for household use.

In such fuel cell systems, during power generation operation, a large amount of water is used for the purposes of cooling the interior of the fuel cell, humidifying an oxidizing gas (air) supplied to a cathode of the fuel cell, and humidifying a fuel gas (hydrogen-rich gas) supplied to an anode of the fuel cell.

It is difficult to say that an infrastructure for supplying a hydrogen gas to the fuel cell system has been built in satisfactory level. A hydrogen generator configured to generate the hydrogen gas through a reforming reaction of a feed gas, such as a city gas or LPG, which are supplied from the existing gas supply infrastructure, is equipped in the fuel cell. Water as well as the feed gas is used for the gas reforming reaction in the hydrogen generator.

Thus, water is indispensable for the fuel cell system. The water supply infrastructure has satisfactorily been built, and is capable of appropriately supplying the water to be used in the fuel cell system.

Meanwhile, during power generation of the fuel cell system, the hydrogen gas is oxidized to generate a large amount of water within the fuel cell. It is desirable to recover the water generated during the power generation operation of the fuel cell system and to re-use it, from the point of view of enabling a water self-sustaining operation, which is not dependent on the existing water supply infrastructure. A water recovery device having such a function is also normally equipped in the fuel cell.

An ionic conductivity of an electrolyte membrane, which allows hydrogen ions to travel from the anode to the cathode, is affected by a condition of the water causing the ionic conductivity.

For example, when a large amount of metal ions are contained in water, the electrolyte membrane of the fuel cell is contaminated with the ions, resulting in decreased ionic conductivity. This leads to degradation of the power generation characteristics of the fuel cell.

In a case where city water is supplied from the existing water supply infrastructure to the fuel cell system, catalyst of the hydrogen generator is poisoned with calcium ions or chlorine content in the city water.

To approximately maintain an activity of the catalyst used for generating a hydrogen gas, it is also important to reduce an amount of metal ions in water. For example, if a nickel compound originating from nickel ions adheres to a steam reforming reaction catalyst, then thermal decomposition of the feed gas is promoted, causing carbon to be deposited on the catalyst.

Of course, by operating the fuel cell system in a circulation type water self-sustaining mode, the content of an ion component in the water can be suppressed. This advantageously lessens a load of a water treatment device, and hence increases its lifetime. However, a certain amount of ionic impurities such as carbonate ions and metal ions are left in the water recovered by the water recovery device. Accordingly, some ionic-impurities treatment is indispensable for the recovered water.

As can be understood from the situation described above, the management of the water causing the ionic conductivity of the electrolyte membrane and the water used in the hydrogen generator has been basically directed to removing the ion component. To this end, a water treatment device, which enables a large ion exchange resin to remove the ions contained in the water used in the fuel cell system, is disposed in the fuel cell system, and its technical development also progresses. For example, an ion exchange water treatment device for removing impurities contained in the water recovered from a combustion exhaust gas and an off gas has been developed (see Patent Document 1).

The hydrogen gas generation using the feed gas progresses through a catalytic reaction of a reforming catalyst. The city gas as the feed gas is added with a sulfur-base odorous component, or contains a sulfur compound originating from the city gas.

The catalyst used for the hydrogen generation, particularly the reforming catalyst serving to remove the feed gas is easily poisoned by sulfur in such a sulfur compound, and an activity of the catalyst deteriorates in an environment where the sulfur is present.

Because the fuel cell system is expected to be operated for a long time period, it is essential to remove the sulfur from the feed gas before the feed gas is supplied to the hydrogen generator.

Known examples are a normal-temperature desulfurization process for removing the sulfur from the feed gas using an appropriate absorbent, and a hydrogenerated desulfurization process in which a hydrogen gas is added to the feed gas to hydrogenate the sulfur compound into a hydrogen sulfide, and then the hydrogen sulfide is removed using an appropriate absorbent.

Recently, it has been found that there is a clear correlation between a sulfur concentration in the feed gas that has undergone the desulfurization process and a lifetime of the reforming catalyst. For this reason, to further increase the lifetime of the reforming catalyst, it is desirable to reduce the sulfur concentration to the lowest possible level. For example, there has been developed a technology for reducing the amount of the sulfur in the feed gas to 1 vol.ppb or less by the hydrogenerated desulfurization process using a copper-zinc base desulfurizing agent (see Patent Document 2).

Further, there has been proposed a method of removing the sulfur from the feed gas in advance in a petroleum hydrocarbon that liquefies the feed gas in such a manner that a basic functional group is carried on a carrier of an desulfurizing agent, and the desulfurizing agent is contacted with the feed gas to appropriately remove the sulfur (see Patent Document 3).

Patent Document 1: Japanese Laid-Open Patent Application Publication No. 5-82147

Patent Document 2: Japanese Patent No. 2765950 Specification

Patent Document 3: Japanese Laid-Open Patent Publication No. 2001-279261

### DISCLOSURE OF THE INVENTION

### Problem to be Solved by the Invention

As described above, it appears that the conventional fuel cell system equipped with the hydrogen generator is constructed to completely prevent activity deterioration of various catalysts or characteristic deterioration of the electrolyte membrane, which may be caused by the impurities, by reliably removing sulfur originating from a feed gas and ionic impurities originating from the water with an appropriate device.

However, so far as the inventors of the present application know, there is serious oversight in the impurity removal process in such a fuel cell system. The oversight is the fact that the sulfur compounds originating from the water which are other than the ionic compounds, for example, a nonionic organic sulfur compound, is present.

Similarly to the case where the catalyst for the hydrogen gas generation is poisoned by the sulfur compound contained in the feed gas and its activity deteriorates, the catalyst is also poisoned by the sulfur compound contained in the reforming water.

Problems associated with the reforming catalyst, which arise from the sulfur compound of the reforming water, will be described in detail using an example of the reforming catalyst based on the steam reforming reaction catalyst.

When the sulfur compound (e.g. sulfuric acid ions) is present in the reforming water, the sulfuric acid ions are hydrogenated into a hydrogen sulfide by a hydrogen gas generated on the basis of the reforming catalyst, and the reforming catalyst is poisoned by the hydrogen sulfide.

Fortunately, the existing water treatment device for removing the ion components uses both cation exchange resin for removing metal ions, and anion exchange resin. The sulfuric acid ions are appropriately removed by the water treatment device before it is used as the reforming water.

In a case where a nonionic organic sulfur compound is present in the reforming water rather than the ionic sulfur compound, it cannot be removed by the ion exchange resin. If the water containing this sulfur compound is supplied as reforming water to the reformer, the sulfur compound is hydrogenated into a hydrogen sulfide by the reforming catalyst, and the resultant hydrogen sulfide poisons the reforming catalyst.

The inventors have dedicated themselves to seeking the possibility that such sulfur compound is present in the reforming water, and have found a fact that due to the elution of additives of resin or rubber used for water pipe material (e.g., benzothiazole as a crosslinking agent of resin and rubber), a nonionic sulfur compound is not completely removed by the water treatment device using the ion exchange resin, and mixes into the reforming water. Furthermore, there is a possibility that in a polymer electrolyte fuel cell using the polymer electrolyte membrane containing sulfonate groups, the electrolyte membrane is decomposed, and a polymer material having sulfonate groups is not completely removed by the water treatment device using the ion exchange resin, and mixes into the reforming water.

Most of the water piping systems for the conventional phosphoric acid type fuel cell for business use are made of stainless steel, and no problem arises if the ionic sulfur compound such as sulfuric acid ions is appropriately removed. This may prevent those persons skilled in the art from being aware of the poisoning of the reforming catalyst by the nonionic sulfur compound originating from the water.

It is presumed that the nonionic sulfur compound has been removed to some extent by, for example, the physical adsorption to activated carbon. The current water piping systems for the home fuel contain much resin and rubber for cost-reduction purpose. It is considered that, in the case where only the removal of the nonionic sulfur compound depending on the physical adsorption to the activated carbon is employed, the total removal amount of the sulfur compound is limited. For this reason, it is difficult to appropriately remove the sulfur compound from the water containing a large amount of sulfur compound. The problems associated with the sulfur compound described above will probably appear during technical development of the home fuel cell into its practical use.

While the relation between the reforming catalyst for the hydrogen gas generation and the nonionic sulfur compound in the reforming water has been described above, it is presumed that the catalyst for the power generation electrode in the interior of the fuel cell, is subject to the sulfur poisoning as in the reforming catalyst for the hydrogen gas generation, and if the water for humidifying the hydrogen gas supplied to the anode of the fuel cell and the oxidizing gas supplied to the cathode thereof contains the nonionic sulfur compound, then power generation electrode catalyst is poisoned by the sulfur compound contained in the humidified hydrogen gas or oxidizing gas. This results in degradation of a power generation characteristic of the fuel cell.

The present invention has been made in view of the above conditions, and an object of the present invention is to provide a fuel cell system which is capable of appropriately removing nonionic sulfur compound contained in recovered water of a water recovery device that is used to generate a hydrogen-containing gas by a hydrogen generator, and a method for operating the fuel cell system.

### MEANS TO SOLVE THE PROBLEMS

To solve the problems, a fuel cell system of the present invention comprises: a hydrogen generator configured to generate a hydrogen-containing gas from a feed gas and steam; a fuel cell configured to generate electric power using the hydrogen-containing gas and an oxidizing gas; a water recovery device configured to recover water generated through the electric power generation; a first water cleaning device including an ion exchanger for removing ionic impurities contained in the water recovered by the water recovery device; a second water cleaning device configured to remove a nonionic sulfur compound contained in the water recovered by the water recovery device, by chemical adsorption; and a water supplying passage configure to guide, to the hydrogen generator, the water which has been taken out of the water recovery device and has flowed through the first and second water cleaning devices.

With such a configuration, the nonionic sulfur compound contained in the recovered water can be removed by chemical adsorption in which chemical bonds are formed. Therefore, the total removal amount of the sulfur compound can be increased.

The water recovered by the water recovery device may be flowed through the second water cleaning device, and then guided to the first water cleaning device.

Thereby, the ionic impurity generated in the second water cleaning device can be appropriately removed in the first water cleaning device.

The water recovered by the water recovery device may be flowed through the first water cleaning device, and then guided to the second water cleaning device.

This makes it possible to prolong a replacement period of the second water cleaning device (lifetime prolongation measure).

The second water cleaning device contains Ag, for example.

A silver (Ag) metal has an excellent binding capability with sulfur and hence, the second water cleaning device containing silver is promising a sulfur compound removal device.

The second water cleaning device also contains Cu, for example.

In some cases, the use of inexpensive copper (Cu) advantageously contributes to cost reduction of the fuel cell system.

The second water cleaning device contains Ru, for example.

Ruthenium (Ru) is inferior to silver in binding capability with sulfur, but is superior to silver in decomposition capability with sulfur. For this reason, there are cases where the second water cleaning device containing ruthenium is useful as a sulfur compound removing device having an immediate effectivity.

An example of the second water cleaning device includes an activated carbon, and is structured such that at least one metal selected from Ag, Cu and Ru is carried on the activated carbon.

Another example of the second water cleaning device includes an oxide selected from silica, alumina and titania, and is structured such that at least one kind of metal selected from Ag, Cu and Ru is carried on the oxide.

The activated carbon and the oxide are each capable of physically adsorbing the nonionic sulfur compound. Since at least one kind of metal of Ag, Cu and Ru is carried on the activated carbon or the oxide and hence, the metal exhibits a catalytic activity for the sulfur compound, the sulfur compound physically absorbed is decomposed. During the decomposing process, the metal chemically reacts with the sulfur, and the resultant is fixed as sulfide.

A method for operating a fuel cell system of the present invention comprises a hydrogen generation step of generating a hydrogen-containing gas from a feed gas and steam using a reforming catalyst; a power generation step of generating electric power using the hydrogen-containing gas and an oxidizing gas; a water recovery step of recovering water generated through the electric power generation; a first water cleaning step of removing ionic impurities contained in the water recovered in the water recovery step; a second water cleaning step of removing a nonionic sulfur compound contained in the water recovered in the water recovery step, by chemical adsorption; and a steam generation step of generating the steam utilized in the hydrogen generation step from the water that has gone through the first and second water cleaning steps.

The above-mentioned objects, other objects, features and advantages of the invention will be apparent from the detailed description of the preferred embodiments of the invention in connection with the accompanying drawings.

### EFFECTS OF THE INVENTION

According to the present invention, there are provided a fuel cell system which is capable of appropriately removing nonionic sulfur compound contained in the recovered water from a water recovery device, which is used for generating a hydrogen-containing gas by a hydrogen generator, and a method for operating the fuel cell system.

### BRIEF DESCRIPTION OF THE DRAWINGS

FIG. 1 is a diagram schematically showing a construction of a fuel cell system according to an embodiment 1 of the present invention.

FIG. 2 is a view schematically showing an example of a construction of a water cleaning device in the fuel cell system according to the embodiment 1.

FIG. 3 is a view showing the result of measuring the effect of a concentration of sulfur in a feed gas on a conversion of a reforming catalyst body.

FIG. 4 is a view schematically showing an example of a construction of a water cleaning device in a fuel cell system according to an embodiment 3.

FIG. 5 is a view schematically showing an example of a construction of a water cleaning device in a fuel cell system according to an embodiment 4.

### EXPLANATION OF REFERENCE NUMERALS

1 hydrogen generator
2 material supply device
3 water supply device
4 hydrogen gas supply path
5 fuel cell
6 off-gas path
7 blower
8 total enthalpy heat exchanger
9 air humidifier
10 air exhausting path
11 combustion exhaust gas path
12 water recovery device
13 water reservoir
14 water discharge device
15 water intake device
16 water cleaning device
16a attachable device
16b separating wall
16c casing
16d recovered water port
16e O-ring
17 sulfur removing portion
18 ion exchanger
19 ozone oxidation portion
20 ozone generator
21 ozone introducing portion
22 ozone exhausting portion
23 ultraviolet ray generator
24a inner piping of ultraviolet ray treatment tank
24b outer piping of ultraviolet ray treatment tank
24c upper and lower lids of ultraviolet ray treatment tank
30 pump
31 ultraviolet ray oxidation portion
32a first titanium oxide photocatalyst layer
32b second titanium oxide photocatalyst layer
40 recovered water piping
41 recovered water container
100 fuel cell system

### BEST MODE FOR CARRYING OUT THE PRESENT INVENTION

Hereinafter, preferred embodiments of the present invention will be described with reference to the drawings.

### Embodiment 1

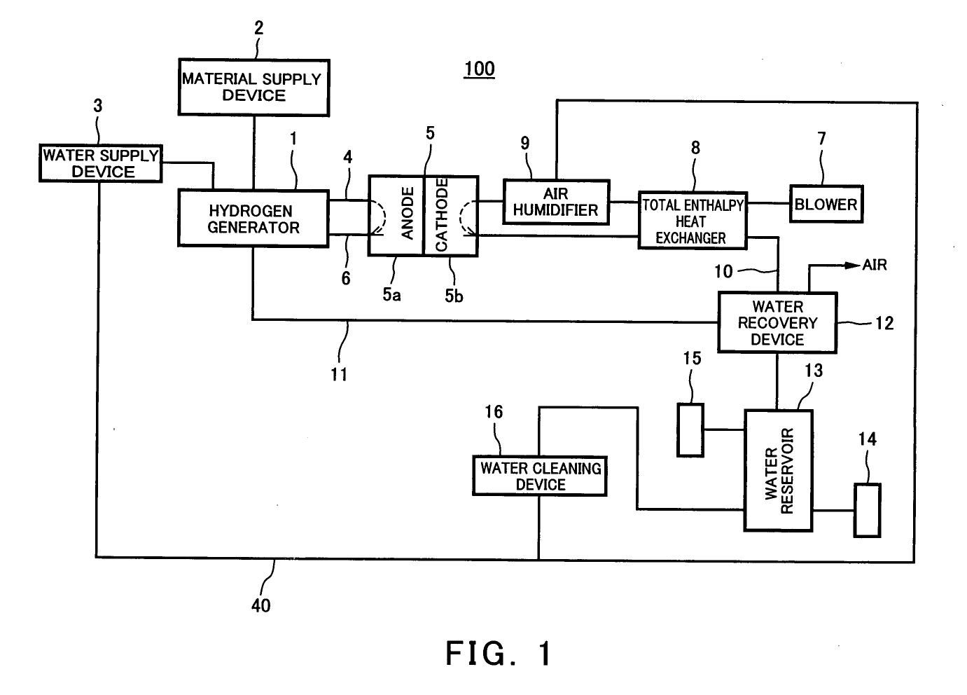

FIG. 1 is a diagram schematically showing a construction of a fuel cell system capable of water self-sustaining operation according to an embodiment 1 of the present invention.

First of all, constructions of a hydrogen generator 1 and a fuel cell 5, which are major devices of a fuel cell system 100, will be described.

The hydrogen generator 1 promotes a reforming reaction based on a mixed gas of steam and a feed gas containing a hydrocarbon component (natural gas, LPG or the like), alcohol (e.g., methanol), a naphtha component, or the like, to thereby generate a hydrogen-rich gas (reformed gas containing a hydrogen gas).

More specifically, the hydrogen generator 1 includes a reformer (not shown) for generating a reformed gas by promoting a reforming reaction of the mixed gas, a shift converter (not shown) for reducing a concentration of a carbon monoxide gas in the reformed gas flowing out of the reformer, and a selective oxidation unit (not shown).

The hydrogen generator 1 is provided with a reforming catalyst body (not shown) that is contained in the reformer, for catalyzing a reforming reaction, and a reformer heater (not shown) for supplying heat required for the reforming reaction of the reforming catalyst body through heat exchange with a combustion gas. The reformer heater is provided with a flame burner for burning a part of the feed gas or an off-gas returned from the fuel cell (to be described later) to generate the combustion gas, and a sirocco fan (not shown) for supplying air used for the combustion of the feed gas or the like.

The shift converter includes a shift converter catalyst which causes a carbon monoxide gas in the reformed gas that has passed through the reformer and steam to react with each other to remove the carbon monoxide gas. The selective oxidation unit contains a CO removal catalyst which oxidizes or methanates the carbon monoxide gas in the reformed gas that has passed through the shift converter to thereby further reduce a concentration of the carbon monoxide gas.

A suitable controller (not shown) controls these devices to be under conditions suitable for the reactions.

The fuel cell 5 is a polymer fuel cell using a polymer material having sulfonate groups for a polymer electrolyte membrane. In the interior of the fuel cell 5, a hydrogen gas is gently oxidized by the electrolyte membrane, the platinum catalyst at a cathode (air electrode) 5b and platinum-ruthenium catalyst at an anode (fuel electrode) 5a to thereby generate electricity.

The fuel cell 5 is also constructed to recover heat generated during the power generation operation of the fuel cell 5 to utilize the heat for hot-water supply.

The hydrogen generator 1 and the fuel cell 5 are constructed based on the conventional technologies and hence, will not be further described.

Next, constructions of gas and water supply/discharge systems in the fuel cell system 100 will be described.

A material supply device 2 is a device for supplying natural gas as the feed gas from an existing gas supply infrastructure to the hydrogen generator 1. A water supply device 3 is a device for supplying reforming water to be used for a reforming reaction from a water cleaning device 16 to be described later to the hydrogen generator 1. The reforming water may be led from an existing water supply infrastructure to the hydrogen generator 1.

A hydrogen-rich reformed gas (from which a carbon monoxide gas is appropriately removed) generated in the hydrogen generator 1 is guided through a hydrogen gas supply path 4 to the anode 5a of the fuel cell 5. The fuel cell 5 consumes the reformed gas supplied to the anode 5a of the fuel cell 5 and oxidizing gas (air) supplied to the cathode 5b of the fuel cell 5 to thereby generate electric power.

An off-gas containing the hydrogen gas which is supplied from the hydrogen generator 1 to the anode 5a of the fuel cell 5, but is not consumed at the anode 5a for the power generation operation of the fuel cell 5, is guided to a flame burner contained in the hydrogen generator 1 through an off-gas path 6, and then is used as a heating material for the reforming reaction of a reforming catalyst body.

A blower 7 is a device for supplying oxidizing gas for power generation to the cathode 5b of the fuel cell 5. A total enthalpy heat exchanger 8 with a total enthalpy heat exchange membrane and an air humidifier 9 for directly humidifying the oxidizing gas with steam generated from warm water are disposed at a location of an air supply path connecting the blower 7 to the cathode 5b. Thereby, the oxidizing gas that is output from the blower 7 and is guided to the cathode 5b of the fuel cell 5 is heated and humidified.

The oxidizing gas which is supplied from the blower 7 to the cathode 5b of the fuel cell 5, but is not consumed at the cathode 5b through the power generation operation of the fuel cell 5, is exhausted to the total enthalpy heat exchanger 8 with the total enthalpy heat exchange membrane, through an air exhausting path 10. The exhausted oxidizing gas transfers its heat and humidity to new oxidizing gas to be supplied from the blower 7 to the fuel cell 5. The oxidizing gas that has passed through the total enthalpy heat exchanger 8 is guided through the air exhausting path 10 to a water recovery device 12.

The combustion gas, which is generated in the flame burner contained in the hydrogen generator 1, exchanges heat with the reforming catalyst body, and then is guided as a combustion exhaust gas to the water recovery device 12 through a combustion exhaust gas path 11.

The water recovery device 12 receives the oxidizing gas flowing in through the air exhausting path 10 and the combustion exhaust gas flowing in through the combustion exhaust gas path 11, and condenses a moisture (fine water droplets and steam), which is generated through the electric power generation operation of the fuel cell 5, and flows together with the oxidizing gas, and moisture flowing together with the combustion exhaust gas, thereby obtaining recovered water. The combustion exhaust gas and the oxidizing gas, from which the moisture has been removed, are discharged into the air.

The water recovery device 12 water-cools the oxidizing gas and the combustion exhaust gas to condense those gases. Description of the details of the internal construction of the water recovery device 12 is omitted herein.

A water reservoir 13 stores the recovered water obtained from the water recovery device 5. The water reservoir 13 is provided with a water discharge device 14 which may be opened and closed with a suitable opening/closing device (not shown), and a water intake device 15 for taking in a given amount of water from the existing water supply infrastructure.

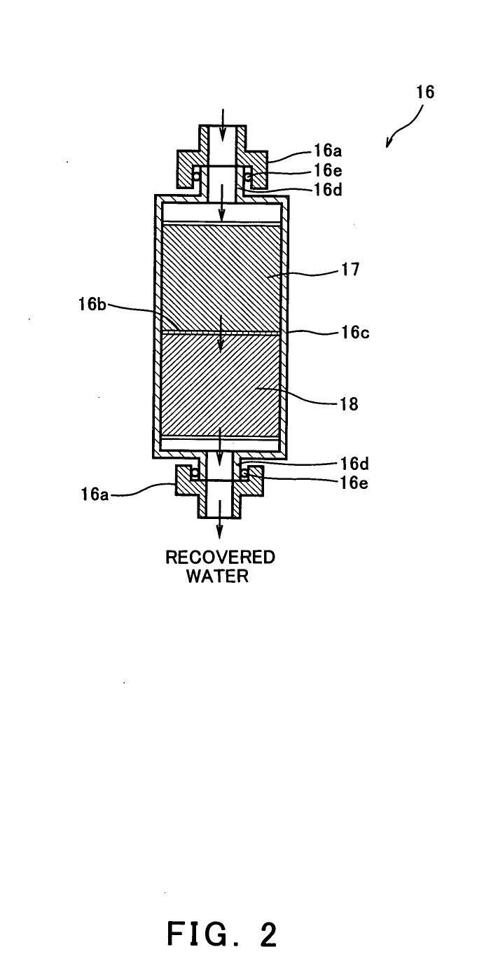

A water cleaning device 16 appropriately cleans the recovered water in the water reservoir 13, and returns the cleaned water to the water supply device 3 and to the air humidifier 9 through a recovered water pipe (water supply path) 40. The construction of the water cleaning device 16 will be described in detail with reference to FIG. 2.

FIG. 2 is a view schematically showing a construction example of the water cleaning device in the fuel cell system according to the embodiment 1.

The water cleaning device 16 includes a cylindrical casing 16c having an upper lid and a lower lid which are respectively provided with recovered water ports 16d, and a pair of attachable device 16a which are each fit to the casing 16c with the recovered water port 16d and an O-ring 16e interposed between them so as to permit the recovered water to flow and are each constructed to easily removably attach the casing 16c so that the casing 16c can be replaced easily.

A sulfur removing portion 17 (second water cleaning device) that is located upstream in the flow direction of the recovered water and is filled with a sulfur absorbent capable of removing a nonionic sulfur compound in the recovered water by chemical adsorption, an ion exchanger portion 18 (first water cleaning device) that is located downstream in the flow direction of the recovered water and is filled with an ion exchange resin (an ion exchanger) capable of removing ionic impurities from the recovered water, and a separating wall 16b that is made of porous polypropylene resin, and separates the sulfur removing portion 17 from the ion exchanger portion 18 so as to permit the recovered water to pass therethrough, are disposed within the casing 16c.

An example of the sulfur removing portion 17 is constructed such that at least one kind of metal selected from silver (Ag), copper (Cu) and ruthenium (Ru) is carried on activated carbon (carrier) (details will be described later).

Another example of the sulfur removing portion 17 is constructed such that at least one kind of metal selected from Ag, Cu and Ru is carried on at least one kind of oxide (carrier) selected from silica, alumina and titania (details will be described later).

An example of the ion exchanger portion 18 is filled with, for example, anion and cation exchange resins.

With such a construction of the water cleaning device 16, water flowing out of the water reservoir 13 passes through the sulfur removing portion 17, and then flows into the ion exchanger portion 18, within the casing 16c.

The ion exchanger portion 18 located downstream of the sulfur removing portion 17 is able to appropriately remove some ionic impurities generated in the sulfur removing portion 17, for example, ionic impurities resulting from ion elution from metal such as silver which is carried on the carrier in the sulfur removing portion 17.

In this embodiment, in design of the fuel cell system, the ion exchanger portion 18 is located downstream of the sulfur removing portion 17, because priority was given to appropriate removal of the ionic impurity generated in the sulfur removing portion 17.

Alternatively, as a reversed arrangement, the sulfur removing portion may be located downstream of the ion exchanger portion in order to give priority to a measure for promoting a replacement period of the sulfur removing portion (lifetime prolongation measure).

This can eliminate an unwanted situation where an impurity removal material (e.g., Ag carried on the carrier in the sulfur removing portion) in the sulfur removing portion unintentionally reacts with ionic impurities such as sulfuric acid ions, or impurities such as mercaptan which have polarity and are easily ionized, causing the sulfur removing portion to be forced to be replaced with a new one in a short period. In other words, the ionic impurities such as sulfuric acid ions are removed in the ion exchanger portion located upstream and as a consequence, a load placed on the impurity removal material in the sulfur removing portion located downstream is lessened.

A construction of the sulfur removing portion 17, which makes the fuel cell system 100 according to the embodiment 1 distinct from the conventional fuel cell system, will be described in detail.

First, deterioration of a conversion (reaction rate) of a reforming catalyst body, which is caused by sulfur, was measured in order to gather basic data for understanding the role of the sulfur removing portion 17.

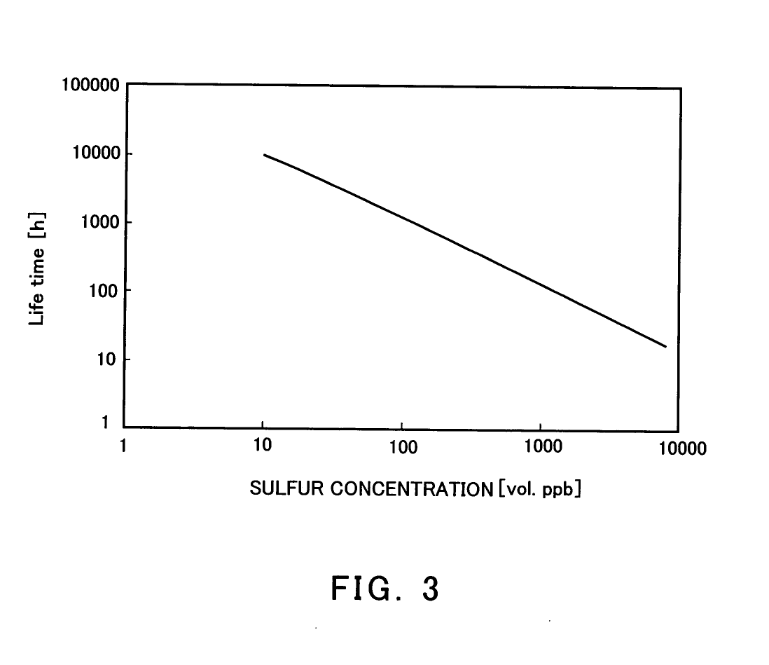

FIG. 3 shows the result of measurement, which was conducted about how a sulfur concentration of the feed gas affected the conversion of the reforming catalyst body, in which an abscissa axis indicates the sulfur concentration of the sulfur compound in the feed gas and an ordinate axis indicates time (lifetime) within which the conversion of the feed gas by the reforming catalyst body can be kept at a predetermined level under the condition in which the temperature of the reforming catalyst body is kept at 650° C.

While in this measurement, the sulfur concentration of the feed gas can be evaluated, it was confirmed that the concentration of the sulfur compound in the reforming water exhibits the test result similar to that shown in FIG. 3.

A ruthenium catalyst was used as the reforming catalyst body, and a methane gas is used as the feed gas. A predetermined amount of dimethyl sulfide (organic sulfur compound) was added to the methane gas. Further, an S/C (steam/carbon ratio) was adjusted to 3, and a feed gas flow rate was adjusted to 3,000/hour in terms of SV (space velocity).

As can be seen from FIG. 3, there exists a clear correlation between a concentration of the sulfur passing through the reforming catalyst body and deterioration of the conversion of the reforming catalyst body. In brief, if the sulfur concentration can be reduced to 1/10, a time taken for the conversion of the reforming catalyst body to deteriorate can be made to be 10 times longer.

As should be understood from this, it is important to appropriately remove the sulfur compound from the water circulating through the fuel cell system 100, which causes the catalyst deterioration, like the sulfur compound in the feed gas.

As already stated, as the result of the elution of additives of resin or rubber used for the water pipe material (e.g., benzothiazole as a crosslinking agent), such an organic sulfur compound may contact the recovered water circulating in the fuel cell system 100 and mix into the same.

If the organic sulfur compound exists in the recovered water, it cannot be removed by the ion exchange resin. And, the sulfur compound remaining in the recovered water is hydrogenated into hydrogen sulfide by a catalyst for the hydrogen generation (e.g., reforming catalyst), and the resultant hydrogen sulfide poisons the catalyst.

Likewise, the platinum catalyst at the cathode 5b of the fuel cell 5, and the platinum-ruthenium catalyst at the anode 5a of the fuel cell 5 are poisoned with the sulfur compound. Sulfur atoms in the molecules tend to be absorbed into the active points of the noble metal catalyst. If the active points of the catalyst are covered with sulfur, then oxidation of the hydrogen ions at the cathode 5b is hindered and the ionization of the hydrogen gas at the anode 5a is hindered, causing voltage of the generated power of the fuel cell 5 to drop. As a result, its power generation characteristic deteriorates.

To address this problem, in the embodiment 1, the sulfur removing portion 17 is disposed in the water cleaning device 16 to reliably remove the sulfur compound that is unable to be removed by the conventional ion exchange resin.

For this reason, it is very important to select the sulfur absorbent (sulfur removal agent) in the sulfur removing portion 17 that determines the removal capability of the organic nonionic sulfur compound. In this embodiment, as a representative sulfur absorbent, a material capable of complementing physical adsorption to the activated carbon with chemical adsorption accompanied with chemical reaction to absorb the sulfur compound, for example, silver (Ag)-impregnated activated carbon will be described. The silver-impregnated activated carbon contains an activated carbon as a carrier on which the silver metal is carried. The carrier has a spherical shape having a diameter of 3 mm.

Initially, an example of an evaluation of the sulfur compound removal characteristic based on physical adsorption of an activated carbon filter itself that uses a fibrous activated carbon and is not impregnated with silver (manufactured by SIBATA Scientific Technology Ltd.) will be described.

In this evaluation, the water that has been adjusted to contain 100 ppm benzothiazole (organic nonionic sulfur compound) in weight ratio was flowed through the activated carbon filter, and its sulfur compound removal effect was evaluated. An amount of the water flowing through the filter per minute was 20 g, and a capacity of the activated carbon filter was about 0.1 L. The result was that a benzothiazole absorption amount finally reached about 2% of the weight of the activated carbon filter. A reduction rate of the benzothiazole in the water was about 90% when the amount of the benzothiazole before it was passed through the activated carbon filter is compared to that after it was passed through the filter.

For this reason, when the activated carbon filter is used, it is desirable to use the silver-impregnated activated carbon that complements the sulfur compound absorbing function, in order to increase the total removal amount of the sulfur compound of sulfur absorbent. Hereinbelow, how to remove the sulfur compound by the silver-impregnated activated carbon will be described.

By flowing the water containing the sulfur compound such as benzothiazole through the silver-impregnated activated carbon, the sulfur compound is physically adsorbed to the porous activated carbon quickly. Subsequently, the sulfur compound physically adsorbed is decomposed since the silver metal is highly dispersed in the activated carbon and therefore exhibits a catalytic activity for the sulfur compound. During this decomposing process, the silver metal and the sulfur chemically react with each other, and are fixed as silver sulfide (AgS). Therefore, ideally, one mol of sulfur at maximum can be chemically adsorbed with respect to one mol of silver. It should be noted that the sulfur adsorption amount depends on the amount or dispersion degree of the silver.

The activated carbon impregnated with the silver metal having an excellent binding capability (reaction rate; adsorptivity) with respect to sulfur is exemplarily illustrated as the sulfur absorbent. Alternatively, copper (Cu) or ruthenium (Ru), in place of the silver metal, may be used as the impregnated component of the activated carbon. A suitable combination of noble metals of silver, copper and ruthenium may be used as the impregnated component of the activated carbon.

Each of these noble metals has high affinity for the sulfur compound, as the sulfur absorption site, and can be highly dispersed so as to enlarge the specific surface area. Thus, suitably, the activated carbon (sulfur absorbent) impregnated with any of these noble metals tends to increase the total removal amount of the sulfur compound when compared to the activated carbon that is not impregnated with the noble metal.

The silver metal is excellent in binding capability with respect to sulfur, and hence has a great potential for the sulfur absorbent.

The copper-impregnated activated carbon is inferior to the silver-impregnated activated carbon in the sulfur compound removal capability. However, in some cases, the use of inexpensive copper advantageously contributes to cost reduction of the fuel cell system.

To promote the chemical adsorption of the sulfur as a metal sulfide, it is desirable to remove the sulfur component from the organic sulfur compound. It may be presumed that ruthenium is inferior to silver in binding capability with respect to sulfur, but is superior to the silver in decomposing capability (catalytic activity) of the organic sulfur compound. For this reason, there are cases where the ruthenium-impregnated activated carbon is useful as a sulfur compound removal material having an immediate effectivity.

An example of the impregnated component other than the noble metal is a component having a basic property. By impregnating the activated carbon with such a basic component, the total removal amount of the sulfur compound of the activated carbon (sulfur absorbent) can be increased. Specifically, the basic component, like the noble metal, tends to absorb sulfur and to generate sulfide. In the case of the activated carbon impregnated with the basic component, the sulfur is fixed as a sulfide in the activated carbon as compared to the conventional activity mainly based on the physical absorption. As a result, a sulfur absorption capacity of the basic-component impregnated activated carbon is increased as compared to the activated carbon having no impregnated component.

Subsequently, an outline of the power generation operation of the fuel cell system 100 according to the embodiment 1 will be first described with reference to FIG. 1. Following this, results of measurement that has been made about how presence and absence of the sulfur removing portion 17 affected the power generation will be described.

The hydrogen generator 1 receives the natural gas from the material supply device 2 and reforming water from the water supply device 3 to thereby generate hydrogen-rich reformed gas.

The fuel cell 5 generates electric power by consuming the reformed gas supplied from the hydrogen generator 1 to the anode 5a of the fuel cell 5, and the oxidizing gas supplied from the blower 7 to the cathode 5b of the fuel cell 5. To generate the electric power in the fuel cell 5, the solid polymer electrolyte membrane containing sulfonate groups is heated up to about 70° C. so as to cause the membrane to perform its function. To ensure the durability of the electrolyte membrane, the reformed gas (hydrogen gas) and oxidizing gas (air) as power generation gases of the fuel cell 5 need to be humidified up to a dew point approximate to the operation temperature (70° C.) of the fuel cell 5.

A reformed gas humidifying process is performed by controlling a flow rate of the reforming water supplied to the hydrogen generator 1. An oxidizing gas humidifying process is performed in such a manner that heat and humidity in the oxidizing gas discharged from the cathode 5b of the fuel cell 5 are provided using the total enthalpy heat exchanger 8.

If the oxidizing gas is humidified in an insufficient level, the recovered water treated by the water cleaning device 16 is guided to the air humidifier 9, and the oxidizing gas is directly humidified there.

The combustion exhaust gas exhausted from the flame burner built in the hydrogen generator 1 and the oxidizing gas exhausted from the cathode 5b of the fuel cell 5 are supplied to the water recovery device 12. Moisture contained in these gases is condensed into recovered water by the water recovery device 12, and the recovered water is stored in the water reservoir 13. The gas from which moisture has been removed is discharged into the air.

The recovered water stored in the water reservoir 13 is guided to the water cleaning device 16. While the recovered water is flowing through the water cleaning device 16, the nonionic sulfur compound and the ionic impurities are appropriately removed from the recovered water by the water cleaning device 16. The recovered water from which the nonionic sulfur compound and the ionic impurities have been appropriately removed is returned to the water supply device 3 (hydrogen generator 1) and to the air humidifier 9, as desired.

Thus, through a series of the water treatment operations, the water to be used by the hydrogen generator 1 and the fuel cell 5 can be procured within the fuel cell system 100, without any supplemental supply from the water supply infrastructure installed outside the fuel cell system 100. Every time the surplus or shortage of the water in the fuel cell system 100 occurs, the surplus water is discharged through the discharge device 14 connected to the water reservoir 13, or the amount of water corresponding to the water shortage is supplied from the water supply infrastructure to the fuel cell system 100 through the water intake device 15 connected to the water reservoir 13.

The water used for humidifying the oxidizing gas of the fuel cell 5 and the water to be supplied to the hydrogen generator 1 are intentionally added with benzothiazole to be adjusted to be 3 ppm in weight ratio. Under this condition, confirmation experiments were conducted for a case where the above described sulfur removing portion 17 containing the sulfur absorbent absorbing the sulfur compound is provided within the water cleaning device 16 in the water supply system of the fuel cell system 100 and for a case where the sulfur removing portion is not provided, in order to confirm how the use of the sulfur removing portion 17 affects the power generation characteristic and the reforming reaction characteristic of the fuel cell system 100.

In both cases, the power generation operation in the fuel cell system 100 was performed under the same conditions. Description of the detailed operation conditions is omitted here.

It has been confirmed that there is a clear significant difference in an initial voltage drop rate of the electric power generated in the fuel cell 5 between a case using the sulfur removing portion 17 and a case without using sulfur removing portion 17. To be specific, the initial voltage drop was 10 mV/1000 hours when the sulfur removing portion 17 was not provided, whereas it was 5 mV/1000 hours when the sulfur removing portion 17 was provided.

From the measurement results, it is estimated that in the case where the sulfur removing portion 17 is not provided, the benzothiazole mixed into the water which is supplied to humidify the oxidizing gas, is present in a mist state together with the steam in the oxidizing gas, and is supplied, together with the oxidizing gas, to the cathode 5b of the fuel cell 5, resulting in the poisoning of the platinum catalyst of the cathode 5b.

It has been confirmed that there is also a clear significant difference in a conversion of methane gas (feed gas) by the reforming catalyst body (temperature: 650° C.) contained in the hydrogen generator 1 between the case using the sulfur removing portion 17 and the case without using the sulfur removing portion 17. When the sulfur removing portion 17 is not provided, an operation time of the fuel cell system 100 keeping a correct reaction rate of the reforming catalyst body was as little as about 20 hours, whereas when the sulfur removing portion 17 is provided, the correct reaction rate of the reforming catalyst body was kept even after the operation time of the fuel cell system 100 exceeded 1000 hours.

According to the above described measurement, it has been confirmed that by appropriately providing the sulfur removing portion 17 having the sulfur absorbent absorbing the sulfur compound, deterioration of the characteristics of the fuel cell 5 and the hydrogen generator 1, which are caused by the sulfur compound in the water, can be prevented.

### Embodiment 2

In an embodiment 2, absorbents in which noble metals of Ag, Cu and Ru are carried on porous oxide carriers (referred to as oxide carriers) of silica (SiO₂) and/or alumina (Al₂O₃) and/or titanium (TiO₂), are used as the sulfur absorbent. Each of these noble metals has a high affinity for the sulfur compound, as the sulfur absorption site, and can be highly dispersed so as to enlarge the specific surface. The oxide carrier has a spherical shape having a diameter of 3 mm.

The sulfur absorbent was manufactured in such a manner that an oxide carrier is impregnated with nitrate of each of Ag, Cu and Ru so that carrying amount is set to about 2 wt % in terms of weight ratio, and then the resultant is baked and dried under a temperature condition of about 500° C.

The oxide carrier, as in the case of the activated carbon according to the embodiment 1, can physically adsorb the organic nonionic sulfur compound. The sulfur compound physically adsorbed is decomposed since the noble metal (Ag, Cu or Ru) is present in a high dispersion state within the oxide carrier, and hence, exhibits a catalytic activity for the sulfur compound. During the decomposing process, the noble metal chemically reacts with the sulfur, and the resultant is fixed as sulfide. Thus, the oxide carrier (sulfur absorbent) impregnated with any of the noble metals, like the sulfur absorbent in the embodiment 1, tends to suitably increase the total removal amount of the sulfur compound when compared to the activated carbon that is not impregnated with the noble metal. It should be noted that a material based on a combination of the oxide carrier (sulfur absorbent) impregnated with the noble metals and the sulfur absorbent in the embodiment 1, may be used.

### Embodiment 3

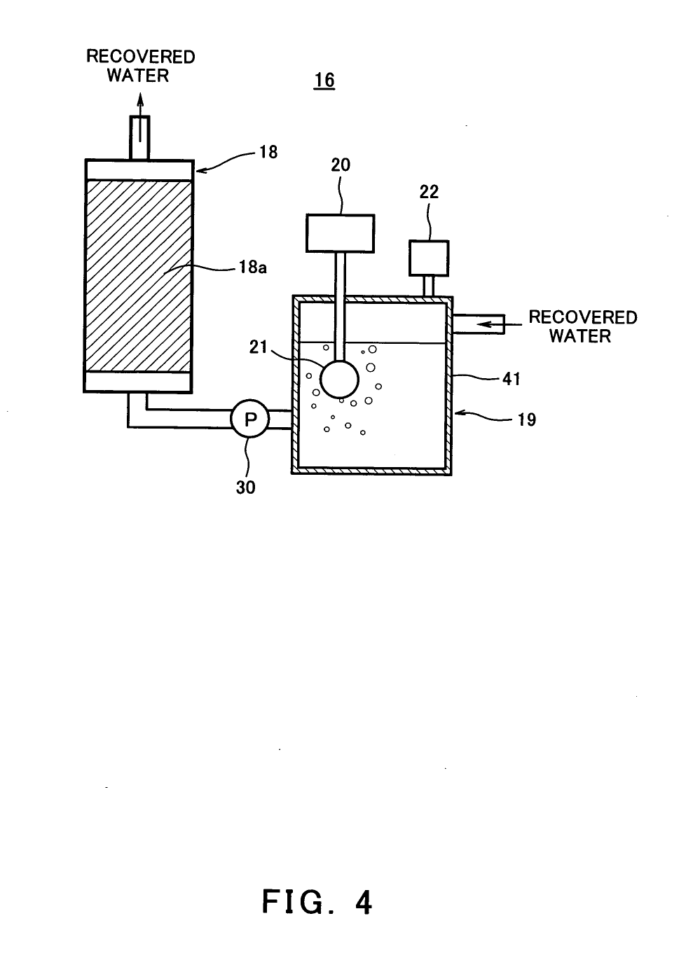

FIG. 4 is a sectional view showing a construction of a water cleaning device in a fuel cell system according to an embodiment 3.

A construction of the fuel cell system except the water cleaning device 16 is the same as that of the fuel cell system 100 described in the embodiment 1, and therefore common components in these systems will not be further described.

As shown in FIG. 4, an ozone oxidation portion 19 (sulfur oxidation device) in the water cleaning device 16 includes a recovered water container 41 for temporarily storing recovered water supplied from the water reservoir 13 (see FIG. 1), a electric discharge ozone generator 20 for generating ozone by electric discharge, an ozone introducing portion 21 comprised of a glass sintered glass ball which efficiently disperses and diffuses the ozone obtained from the electric discharge ozone generator 20 into the recovered water stored in the recovered water container 41, and an ozone exhausting portion 22 which corresponds to a path for exhausting surplus ozone that has not dissolved into the recovered water in the recovered water container 41 and is located on a lid of the recovered water container 41 so as to contain an ozone decomposition catalyst (not shown) for detoxifying the discharged ozone.

An ion exchanger portion 18 (ion exchanging device) containing ion exchange resin 18a is disposed downstream of the ozone oxidation portion 19 in the flow direction of the recovered water. The recovered water stored in the recovered water container 41 of the ozone oxidation portion 19 is supplied with a pressure toward the ion exchanger portion 18 by a pump 30 disposed at a location of a pipe connecting the ozone oxidation portion 19 to the ion exchanger portion 18.

By diffusing the ozone into the recovered water stored in the recovered water container 41, the organic nonionic sulfur compound is oxidized and decomposed by the action of ozone, so that the sulfur compound is transformed into sulfuric acid ions or sulfite ions. It is estimated that the sulfur transformed into sulfuric acid ions or sulfite ions can be properly removed by the ion exchanger portion 18 located downstream of the ozone oxidation portion 19 in the flow direction of the recovered water.

It is expected that the sulfur absorbing method based on the ozone oxidation treatment according to the embodiment 3 has the sulfur compound removal capability being satisfactorily useful. This sulfur absorbing method may be used in combination with the sulfur absorbent described in the embodiments 1 and 2.

The absorbing method based on the ozone oxidation treatment has a useful effect that it can oxidize various kinds of organic sulfur compounds and other organic compounds, in addition to the benzothiazole.

While ozone is added in the oxidation method of the organic sulfur compound, hydrogen peroxide water may alternatively be added in place of the ozone.

### Embodiment 4

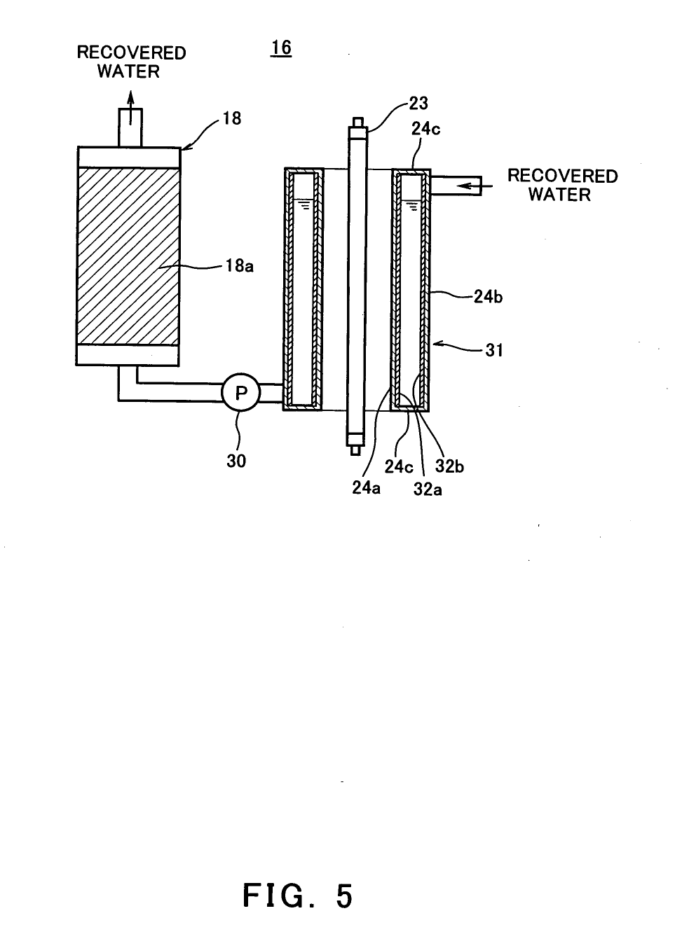

FIG. 5 is a view schematically showing a construction example of a water cleaning device in a fuel cell system according to an embodiment 4.

A construction of the fuel cell system except the water cleaning device 16 is the same as that of the fuel cell system 100 described in the embodiment 1, and therefore common components in these systems will not be further described.

As shown in FIG. 5, an ultraviolet ray oxidation portion 31 (sulfur oxidation device) in a water cleaning device 16 includes a rod-shaped ultraviolet ray generator 23 (light irradiating device) for generating ultraviolet rays, an ultraviolet ray treatment tank which is disposed coaxially with the center axis of the ultraviolet ray generator 23, and includes a cylindrical inner pipe 24a, a cylindrical outer pipe 24b, and annular upper and lower lids 24c connecting both axial ends of the inner and outer pipes 24a and 24b, a first titanium oxide photocatalyst layer 32a cylindrically coated on the outer peripheral surface of the inner pipe 24a, and a second titanium oxide photocatalyst layer 32b cylindrically coated on the inner peripheral surface of the outer pipe 23b.

The ultraviolet ray treatment tank is constructed to temporarily store, in an inner space thereof, the recovered water supplied from the water reservoir 13 (see FIG. 1).

An ion exchanger portion 18 (ion exchanging device) containing ion exchange resin 18a is disposed downstream of the ultraviolet ray oxidation portion 31 in the flow direction of the recovered water. The recovered water stored in the ultraviolet ray treatment tank of the ultraviolet oxidation portion 31 is supplied with a pressure toward the ion exchanger portion 18 by a pump 30 disposed at a location of a pipe connecting the ultraviolet ray oxidation portion 31 to the ion exchanger portion 18.

By emitting the ultraviolet rays generated in the ultraviolet ray generator 23 toward first and the second titanium oxide photocatalyst layers 32a and 32b, the organic nonionic sulfur compound is oxidized and decomposed on the basis of water present and the dissolved oxygen in the recovered water by the action of the titanium oxide catalyst irradiated with ultraviolet rays. As a result, this sulfur compound is transformed into sulfuric acid ions or sulfite ions. It is estimated that the sulfur transformed into the sulfuric acid ions or sulfite ions can be appropriately removed by the ion exchanger portion 18 located downstream of the ultraviolet oxidation portion 31 in the flow direction of the recovered water.

The first titanium oxide photocatalyst layer 32a is sufficiently thinner than the second titanium oxide photocatalyst layer 32b so that light emitted from the ultraviolet ray generator 23 can be transmitted through the first titanium oxide photocatalyst layer 32a. Oxidization and decomposition of the sulfur compound by the titanium oxide catalyst is appropriately performed at the interface between the first and the second titanium oxide photocatalyst layers 32a and 32b and the recovered water.

Irradiation of the photocatalyst layers with the ultraviolet rays brings about the secondary effect that bacteria present in the recovered water are sterilized.

It is expected that the sulfur absorbing method based on the ultraviolet ray oxidation process according to the embodiment 4 has the sulfur compound removal capability being satisfactorily useful. Such a sulfur absorbing method may be used in combination with the sulfur absorbent described in the embodiments 1 and 2. The absorbing method based on the ultraviolet oxidation process, like in the embodiment 3, has a useful effect that it can oxidize various kinds of organic sulfur compounds and other organic compounds, in addition to the benzothiazole.

Numerous modifications and alternative embodiments of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention and all modifications which come within the scope of the appended claims are reserved.

### INDUSTRIAL APPLICABILITY

The fuel cell system according to the present invention is able to appropriately remove a nonionic sulfur compound contained in recovered water in the water recovery device that is used for generating the hydrogen-containing gas by the hydrogen generator, and therefore is useful when it is applied to home power generating systems.

1. A fuel cell system comprising:
a hydrogen generator configured to generate a hydrogen-containing gas from a feed gas and steam;
a fuel cell configured to generate electric power using the hydrogen-containing gas and an oxidizing gas;
a water recovery device configured to recover water generated through the electric power generation;
a first water cleaning device including an ion exchanger for removing ionic impurities contained in the water recovered by said water recovery device;
a second water cleaning device configured to remove a nonionic sulfur compound contained in the water recovered by said water recovery device, by chemical adsorption; and
a water supply passage configured to guide, to said hydrogen generator, the water which is taken out of said water recovery device and flows through said first and second water cleaning devices, wherein said second water cleaning device contains at least one metal selected from Cu and Ru.

2. The fuel cell system according to claim 1, wherein the water recovered by said water recovery device is flowed through said second water cleaning device, and then guided to said first water cleaning device.

3. The fuel cell system according to claim 1, wherein the water recovered by said water recovery device is flowed through said first water cleaning device, and then guided to said second water cleaning device.

4-6. (canceled)

7. The fuel cell system according to claim 1, wherein said second water cleaning device includes activated carbon, and is structured such that at least one metal selected from Cu and Ru is carried on said activated carbon.

8. A fuel cell system comprising:
a hydrogen generator configured to generate a hydrogen-containing gas from a feed gas and steam;
a fuel cell configured to generate electric power using the hydrogen-containing gas and an oxidizing gas;
a water recovery device configured to recover water generated through the electric power generation;
a first water cleaning device including an ion exchanger for removing ionic impurities contained in the water recovered by said water recovery device;
a second water cleaning device configured to remove a nonionic sulfur compound contained in the water recovered by said water recovery device, by chemical adsorption; and
a water supply passage configured to guide, to said hydrogen generator, the water which is taken out of said water recovery device and flows through said first and second water cleaning devices, wherein said second water cleaning device includes an oxide selected from silica, alumina and titania, and is structured such that at least one metal selected from Ag, Cu and Ru is carried on said oxide.

9. A method for operating a fuel cell system comprising:
a hydrogen generation step of generating a hydrogen-containing gas from a feed gas and steam using a reforming catalyst;
a power generation step of generating electric power using the hydrogen-containing gas and an oxidizing gas;
a water recovery step of recovering water generated through the electric power generation;
a first water cleaning step of removing ionic impurities contained in the water recovered in said water recovery step;
a second water cleaning step of removing a nonionic sulfur compound contained in the water recovered in said water recovery step, by chemical adsorption; and
a steam generation step of generating the steam utilized in said hydrogen generation step from the water that has gone through said first and second water cleaning steps, wherein said second water cleaning device contains at least one metal selected from Cu and Ru.
